(19) United States
(12) Patent Application Publication
(10) Pub. No.: US 2013/0031012 A1
(43) Pub. Date: Jan. 31, 2013

(54) System and Method for Compliance Reporting

(71) Applicant: Howell Conant, Block Island, RI (US)

(72) Inventor: Howell Conant, Block Island, RI (US)

(21) Appl. No.: 13/556,584

(22) Filed: Jul. 24, 2012

Related U.S. Application Data
(60) Provisional application No. 61/511,329, filed on Jul. 25, 2011.

(51) Int. Cl. G06Q 99/00

(52) U.S. Cl. 705/317

(57) ABSTRACT

A method and apparatus for monitoring compliance with jurisdictional regulations. In one aspect, the invention relates to a system for monitoring compliance with jurisdictional regulations. In one embodiment, the system includes a server including a reporting program; a database in communication with the server; and a client device in communication with the server and comprising an input device. In another aspect, the invention relates to a method of monitoring compliance with jurisdictional regulations. In one embodiment, the method includes the steps of: inspecting a location for compliance; entering inspection compliance information using a client input device in communication with a server, the server comprising a database and a reporting program and the database comprising reporting data and location data; executing on the server the reporting program; and automatically communicating compliance reports to a jurisdictional authority in response to reporting data and location data in the database.

### RELATED APPLICATIONS

This application claims priority to U.S. Provisional Application 61/511,329 filed Jul. 25, 2011; which is incorporated herein by reference in its entirety.

### FIELD OF THE INVENTION

The invention relates generally to the field of database reporting systems and more specifically to the field of compliance reporting.

### BACKGROUND OF THE INVENTION

Jurisdictional authorities, typically Federal, State and/or local, require periodic tests and inspections of various buildings and structures to insure that various fire, health and other safety regulations are complied with. Generally, reports are written by hand and which are then required to be filed with the appropriate authority having jurisdiction (“AHJ”). If the required tests and/or inspections are not submitted to the AHJ in a timely manner, the building or structure is in a state of non-compliance. If the test or inspections result in deficiencies noted, the building or structure is in a state of non-compliance. If the non-compliance is severe enough the facility may be cited, fined, or even closed. If the infractions are of a more minor nature, the facilities may simply be cited as being non-compliant.

For example, an office building is periodically inspected according to the regulations of the AHJ, often every three months (quarterly). Most jurisdictions require the safety systems to be inspected by licensed professional private companies. The managing of these inspections is a difficult task for large jurisdictions which may have thousands of building being inspected. The management of these inspections is also difficult for smaller jurisdictions with limited human resources and/or financial resources.

The present invention addresses this management need.

### SUMMARY OF THE INVENTION

The invention relates to a method and apparatus for monitoring compliance with jurisdictional regulations.

In one aspect, the invention relates to a system for monitoring compliance with jurisdictional regulations. In one embodiment, the system includes a server including a reporting program; a database in communication with the server; and a client device in communication with the server and comprising an input device. In one embodiment, the database includes reporting data and location data. In one embodiment, the reporting data are entered into the database from the client device. In another embodiment, the server executes the reporting program and in response to reporting data and location data in the data base automatically communicates compliance reports to a jurisdictional authority. In another embodiment, the client device communicates with the server over a network. In another embodiment, the compliance reports are communicated to management of the location. In still yet another embodiment, the reporting data relates to fire inspections. In yet another embodiment, the compliance reports are communicated to insurance companies.

In another aspect, the invention relates to a method of monitoring compliance with jurisdictional regulations. In one embodiment, the method includes the steps of: inspecting a location for compliance and entering inspection compliance information using a client input device in communication with a server. In one embodiment, the server includes a database and a reporting program and the database includes reporting data and location data. In another embodiment, the method includes the steps of executing, on the server, the reporting program, and automatically communicating compliance reports to a jurisdictional authority in response to reporting data and location data in the database.

In another embodiment, the client device communicates with the server over a network. In yet another embodiment, the method includes the step of communicating compliance reports to the management of the location. In still yet another embodiment, the method includes the step of communicating compliance reports to an insurance company.

In yet another aspect, the invention relates to a tangible memory device comprising a program for executing the method comprising the steps of entered inspection compliance information using a client input device in communication with a server, the server comprising a database and a reporting program and the database comprising reporting data and location data; executing on the server the reporting program; and automatically communicating compliance reports to a jurisdictional authority in response to reporting data and location data in the database.

### DESCRIPTION OF THE DRAWINGS

The objects and features of the invention can be understood more completely by referring to the drawings described below and the accompanying descriptions. In the drawings, like numerals are used to indicate like parts throughout the various views.

FIG. 1 is a highly schematic diagram of an embodiment of a networked system constructed in accordance with the invention;

FIG. 2 is a schematic diagram of a data flow chart of an embodiment of the invention; and

FIGS. 3 A-C is a diagram of the data structures of an embodiment of the invention.

### DESCRIPTION OF AN ILLUSTRATIVE EMBODIMENT

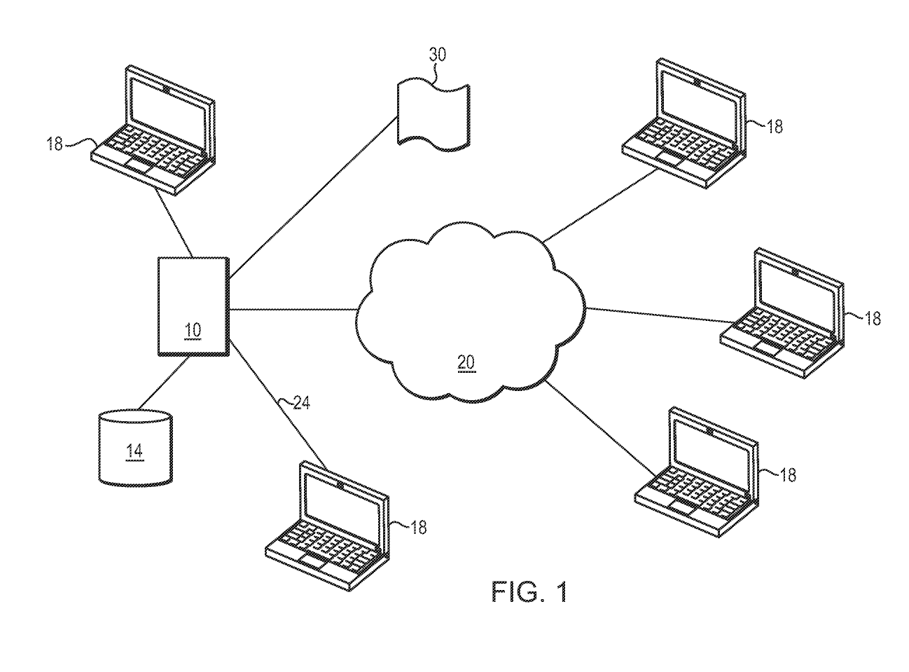

In brief overview and referring to FIG. 1, a system constructed in accordance with the invention includes a server 10 in communication with a database 14. The server 10 in turn is in communication with a client (generally 18). Each client 18 includes an input device by which inspection personnel may enter report information. In various embodiments the server 10 may be as a blade server, a computing cluster, or an individual processor such as in a personal computer. The database 14 in various embodiments may be stored in a random access memory, a solid state disk or a rotating memory device to name but a few. The client 18 in various embodiments may be another computer, a mobile device such as a smart phone, or a special input device constructed for this purpose. The client 18 and the server 10 in various embodiments may communicate over the web 20, a proprietary network, a wireless network or any other communication means having sufficient bandwidth such as a phone line or cable 24.

The server 14 includes inspection software which accepts data from the client 18 and populates the database 14 with the information. The software may be written in a scripting language, a basic system language or any other high level language including but not limited to C++, FORTRAN, or Pascal. The software is also responsible for generating reports 30 and automatically communicating the reports to various jurisdictional authorities by post or electronic means. The database may be a SQL database, an excel database or any other relational database. The reports can take on any form that is acceptable to the jurisdictional authorities. The reports can be interactive whereby hyperlinks allow the user to access additional information. The report data and the report may be written, pictorial or aural as limited only by the client input device, the receiving output device and the bandwidth of the communication system. In addition, software executing on the server 10 also sends notification of the results of the inspection to the owners and or managers of the property using the electronic communication means described above or by generating hardcopy documentation which is then sent by post.

In the case where non-governmental inspectional services are employed to provide the inspections, those third party inspectors can also add information into the database at the time of the initial inspection or at the time of subsequent inspections. The system also provides reminders to the jurisdictional governmental agencies and third party inspectors that the follow-up inspections are due. An example of a data structure constructed in accordance with the invention is provided below. Information relating to the compliance includes, but is not limited to, parameters set by statute such as frequency of inspections, systems to be inspected and penalties for non-compliance, and values related to the locations being inspected, including but not limited to the location of the facility, facility type, building type, ownership of the facility, management of the facility, ownership of the building, management of the building, type of inspection, and agency authorized to do the inspection.

As a non-limiting example, consider a fire inspection. In this example, assume that the statute requires that building fire alarms for buildings having more than two stories be inspected every six months and the local fire departments are to perform the inspections. Also assume that the local and state fire marshal's office is to receive a copy of the results of the inspection.

The database in this one embodiment includes: building location; number of floors; owner name; management name; local jurisdiction; date of last inspection; result code (pass, fail, citation); previous inspector name; and citation to fire code for any violation.

In various embodiments, the system may populate the various parameters itself based on input data and data from other databases such as municipal databases. For example, once the building location is known, the municipal tax database may be accessed by the system to obtain the owner's name and the name of the management company. Further, if the system includes artificial intelligence, the citation to a fire code would permit the system to generate a report in a natural language automatically.

In addition, many building systems must be periodically inspected by third parties to comply with either ordinances or insurance regulations. In such cases, the system may access other databases such as those databases holding certification information for those individuals performing the inspections. In this manner, if the inspector has failed to maintain his or her certification, the system will note this and not indicate that the building system has passed inspection whether or not the putative inspector indicated that it had. In this way, the jurisdiction can manage the use of unqualified inspectors.

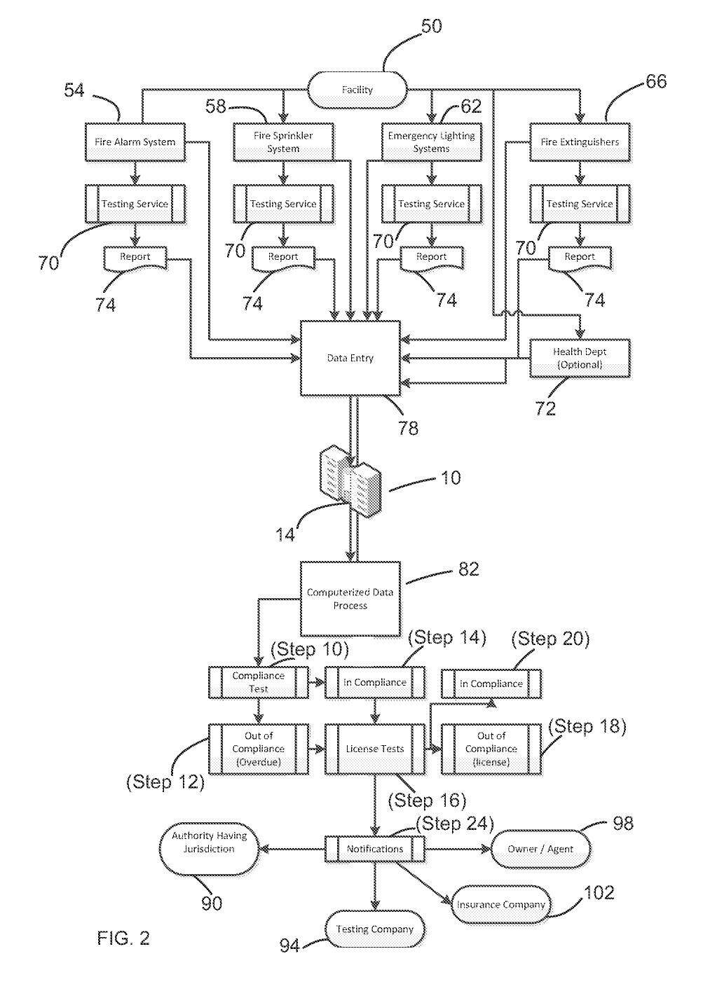

Referring to FIG. 2, the general overview of the data flow is a system constructed in accordance with the invention is shown. A single facility or property 50 such as an office building will have a number of safety systems, including but not limited to, a fire alarm system 54, a sprinkler system 58, an emergency lighting system 62 and fire extinguishers 66 that require periodic inspections. In some circumstances, the facility involves food or medical care and must also be inspected by the health department 72.

Typically, these systems are not all inspected by the same testing service (generally 70). As described above, depending upon jurisdiction, the testing service 70 may be a governmental organization such as the fire department or any of a number of licensed private companies or contractors who do such inspections under contract. Each of the testing services 70 submits a report 74 for data input 78. Data input may take place by data entry from paper reports or may be directly entered into the database 14 through electronic means such as over the web 20.

The data is entered into a database 14 and is processed by the server 10 executing programs 82. The system 82 tests (step 10) to determine if the time since the last inspection for a given system is within the time specified by the jurisdictional regulations. If the facility is not inspected within the required elapsed time (step 12), the system is determined to be out of compliance. If the facility has been inspected within the required elapsed time (step 14) the test is judged in compliance with regard to timeliness of inspection.

In one embodiment, a determination is made as to whether the testing service 70 is properly licensed (step 16). To do this, the system generally has access to the current licensing database of the jurisdiction. If the testing service is not licensed, the facility 50 is determined to be out of compliance (step 18) regardless of whether the lapsed time between inspections has been found to be compliant with regard to timeliness of inspection. If the facility were found to be non-compliant due to an overdue inspection, regardless of the license testing results (step 16), the facility is determined to be non-compliant as to the licensing. If both the timeliness compliance and the license tests show compliance, then the facility is in compliance (step 20).

Once the facility status has been defined as compliant or non-compliant, the system then makes the appropriate notifications (step 24) using the appropriate medium, such as post, facsimile, or email. These notifications, in some embodiments, automatically enter data into the receiver's databank. In other embodiments, those entities entitled to view the results of the inspections may log in to the server and receive reports upon request. Typically, reports are available to the authority having jurisdiction 90, the testing service 94, and the owner and/or agent for the facility 98. In some embodiments, the insurer of the facility 102 is notified and as a result of the outcome of the inspection, the facility may be offered better insurance rates.

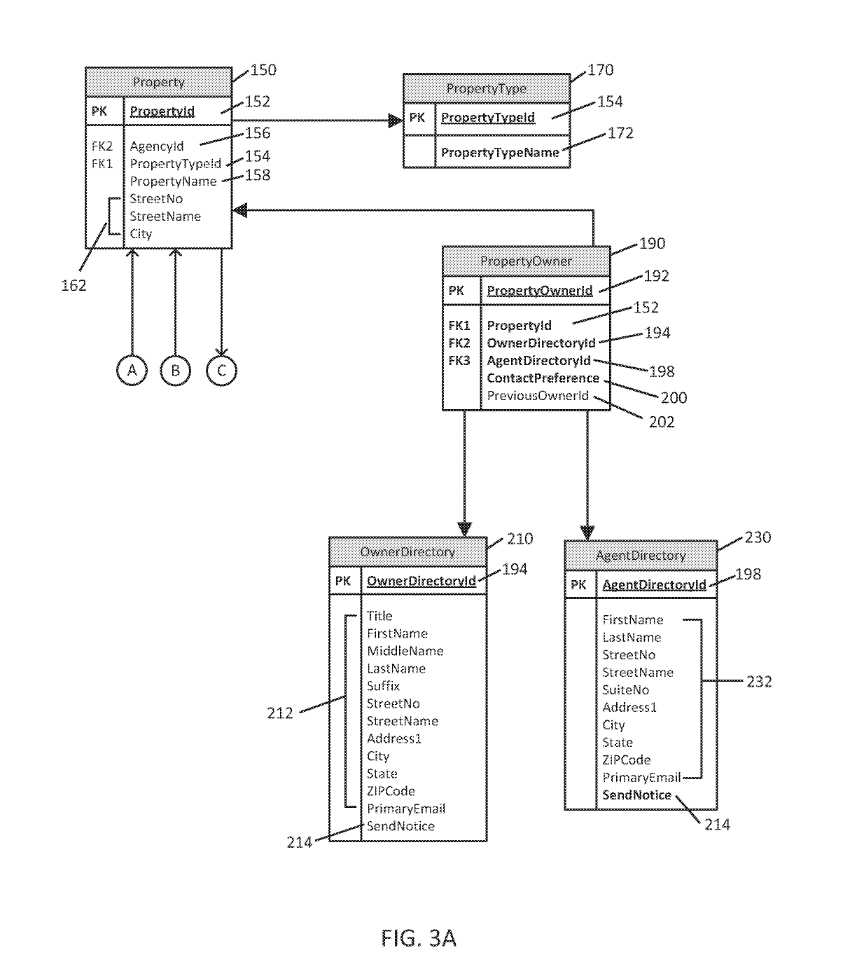

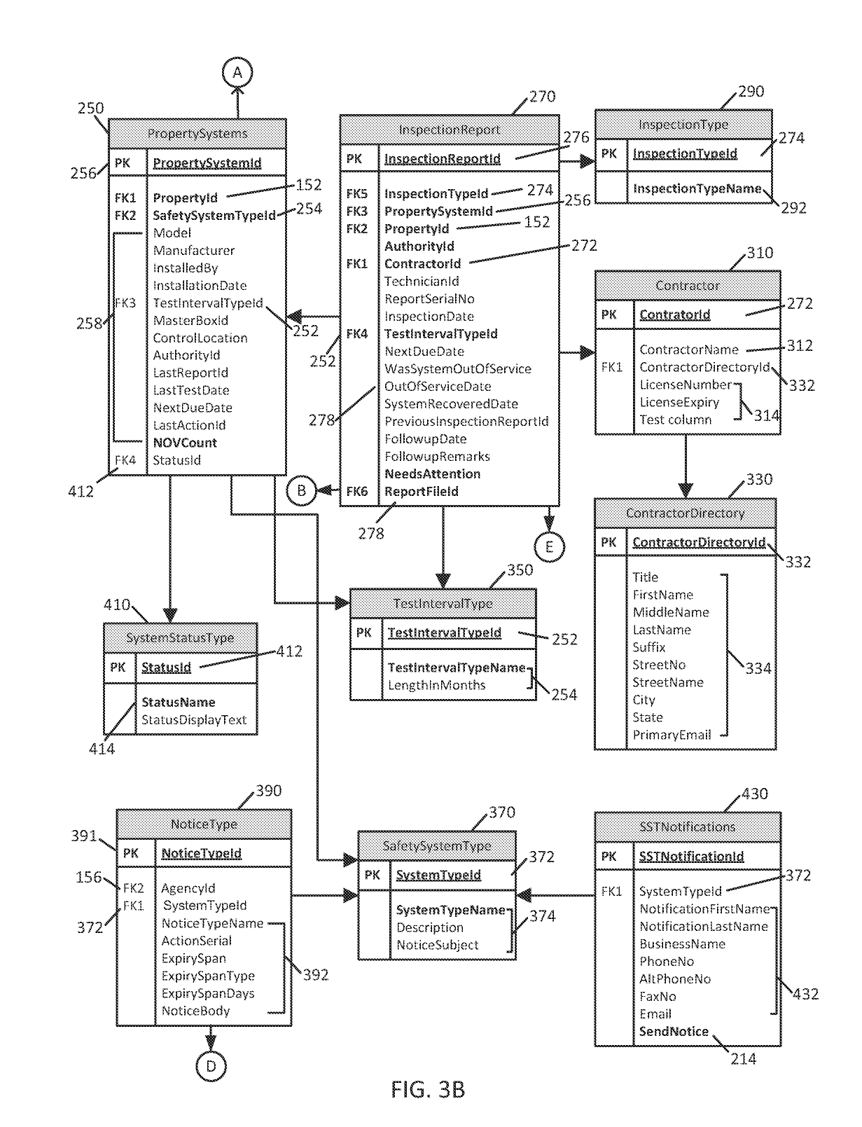

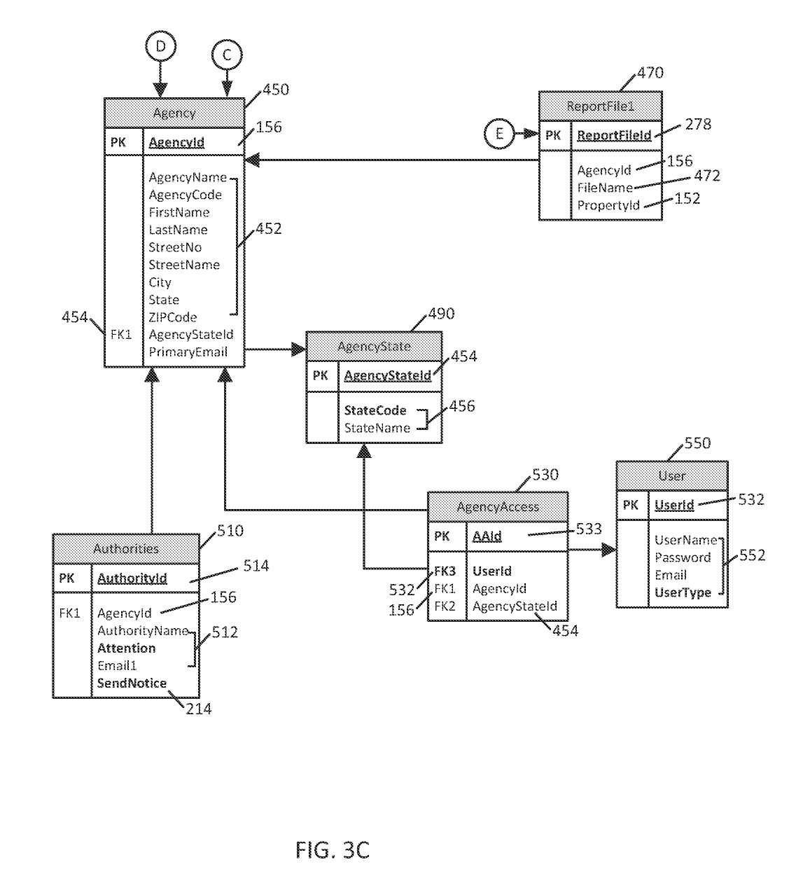

In more detail and referring to FIGS. 3A-C, the data structure for one embodiment of the invention is shown. The internal parameters of the data structures are determined according to the embodiment of the data structure and only the internal parameters which are defined by other data structures and a few exemplary examples of data are shown. Arrows between the data structures show linkages to internal parameters. Keys that are identical between structures have the same number.

In one embodiment there are twenty-one data structures. These data structure are arranged generally into three main groups; the group relating to the property, the group relating to the agencies and the group relating to the inspections. These groupings are somewhat arbitrary; any structure may be moved to a different group and the groups are only used for description and do not affect the functionality of the structures.

In one embodiment, the data structures relating to the property include but are not limited to: the Property data structure 150; the PropertyType data structure 170; the PropertyOwner data structure 190; and the OwnerDirectory data structure 210. The agency data structures include, but are not limited to, the AgentDirectory data structure 230; the Agency data structure 450; the AgencyState data structure 490; the Authorities data structure 510; the AgencyAccess data structure 530 and the User data structure 550. The inspections data structures include the PropertySystems data structure 250; the InspectionReport data structure 270; the InspectionType data structure 290; the Contractor data structure 310; the ContractorDirectory data structure 330; SystemStatusType data structure 410; the TestIntervalType data structure 350; the NoticeType data structure 390; the SafetySystemType data structure 370, the ReportFile1 data structure 470 and the SSTNotifications data structure 430.

Considering each data structure individually, the Property data structure 150 holds data about the property and includes a key PropertyID 152 through which the PropertyOwner 190, the PropertySystems 250, and the inspectionReport 270 data structures are linked to the property. The Property data structure 150 also includes an AgencyID key 156 and a PropertyTypeID 154 which link the Property data structure 150 to the Agency data structure 450 and the PropertyType data structure 170 respectively. The Property data structure 150 contains the name 158 and address 162 of the property.

The PropertyType data structure 170 is linked to the Property 150 by the PropertyTypeID 154 and the PropertyType data structure 170 includes the PropertyTypeName 172, such as commercial, residential, etc.

The PropertyOwner join data structure 190 contains information about the property owner and is linked to the property through the PropertyID 152 and includes the PropertyOwnerID 192. The OwnerDirectoryID 194 and the AgentDirectoryID 198 in the Property Owner data structure 190 provide links to the OwnerDirectory data structure 210 and the Agent Directory 230, respectively. The data in the PropertyOwner data structure 190 includes the owner's contact information 200 and information on the previous owner 202.

The OwnerDirectory data structure 210 includes the OwnerDirectoryID key 194 and data on the owner 212 and whether or not a notice 214 is to be sent to the owner.

The AgentDirectory data structure 230 includes the AgentDirectoryID 198 and data related to the property agent's name and location 232 and whether a notice 214 is to be sent to the agent.

The Agency data structure 450 includes the key AgencyID 156 and the key AgencyStateID 454 and includes data about the property agency such as its name and location 452. The Agency data structure 450 is linked to the AgencyState data structure 490 by the AgencyStateID 454 and contains the StateCode and name 456.

The AgencyAccess join data structure 530 has a key AAID 533 UserID 532; AgencyID 156; and AgencyStateID 454. The AgencyAccess data structure 530 provides the linkages to allow a user listed in the User data structure 550 access to the system.

The User data structure 550 includes the names, passwords and other user information 552 about the users allowed to access the system.

The Authorities data structure 510 is a list of authorities with authority ID including a key AuthorityID 514; and the AgencyID key 156. The data held in this structure includes the Authority or jurisdictional information 512 and whether or not a notice should be sent 214 to the authorities listed.

The PropertySystems data structure 250 provides information about the various systems in place in the property. The data structure includes a PropertySystemID 256 and the PropertyID 152, SafetySystemTypeID 254, TestIntervalTypeID 252, which identifies the property, the type of system in the property and the testing interval, respectively, and also information about the safety system 258. The pointer StatusID 412, points to the SystemStatusType data structure 410 which includes the StatusID key 412 and the data 414, such as “incompliance.” The TestIntervalType data structure 350 includes the TestIntervalTypeID 252 and the TestIntervalTypeName and test interval 254.

The InspectionReport join data structure 270 is linked to the PropertySystems data structure 250 by the PropertySystemID 256 and references the Property data through the PropertyID 152. The structure also points to the Contractor data structure 310 through the ContractorID 272; the TestIntervalType data structure 350 through the TestIntervalTypeID 252 and the InspectionType data structure 290 through the InspectionTypeID 274. The InspectionReport data structure 270 includes data 278 relating to the inspection of a system.

The InspectionType data structure 290 includes a pointer InspectionTypeID 274 to link the data structure to the InspectionReport data structure 270 and contains the InspectionTypeName 292, such as “monitored fire system.”

The data structure ReportFile1 470 includes a ReportFileID 278 which links the datastructure to the InspectionReport data structure 270. The pointer AgencyID 156 links the report file to the Agency data structure 450. The ReportFile1 data structure 470 includes the data FileName 472 and PropertyID 152, which links the file to the property.

The Contractor data structure 310 is linked by the ContractorID 272 to the InspectionReport 270. The data structure also includes a pointer ContractorDirectoryID 332 to the ContractorDirectory 330 and includes the contractor name 312 and the contractor's license information 314. The ContractorDirectory data structure 330 includes a ContractorDirectoryID 332 and contains the information about the inspection contractor 314.

The NoticeType join data structure 390 includes a NoticeTypeID pointer 391 as well as pointers for AgencyID 156 pointing to the Agency data structure 450 and SystemTypeID 372. Finally, the SSTNotifications data structure 430 includes a pointer SSTNotificationID and a pointer SystemTypeID 372 to the SafetySystemType data structure 370. The data in this structure relates to the notifications of issues 432 and a SendNotice flag 214 to indicate that a notice is to be sent to the parties indicated.

Although this is shown as one embodiment, other data structures are possible without deviating from the scope of the invention.

The manner in which the out-of-compliance situation is addressed is modified and customized depending on such things as Agency regulations and rules. This may differ from State to State, and Agency to Agency. Data queries seek out, for example, an out of compliance condition and as a result generate notices to entities associated with the property and safety system in question. The notices are merge processes that apply the various relationship data. Agencies, however, receive notifications differently than Owners and Agents since they could conceivably get hundreds of emails per day if they received one notice per safety system as do the Owners and Agents. Any Owner, Agent, or Agency that is associated to the Property, will received notification one way or another any time there is an out of compliance condition.

Having thus described certain embodiments of the present invention, various alterations, modifications, and improvements will be apparent to those skilled in the art. Such variations, modifications and improvements are intended to be within the spirit and scope of the invention. Accordingly, the foregoing description is by way of example only and is not intended to be limiting.

What is claimed is:

1. A system for monitoring compliance with jurisdictional regulations comprising:
a server comprising a reporting program;
a database in communication with the server;
a client device in communication with the server and comprising an input device;
wherein the database comprises reporting data and location data;
wherein reporting data are entered into the database from the client device; and
wherein the server executes the reporting program and in response to reporting data and location data in the data base, automatically communicates compliance reports to a jurisdictional authority.

2. The system of claim 1 wherein the client device communicates with the server over a network.

3. The system of claim 1 wherein the compliance reports are communicated to management of the location.

4. The system of claim 1 wherein the reporting data relates to fire inspections.

5. The system of claim 4 wherein the reporting data relates to fire alarms.

6. The system of claim 1 wherein the reporting data relates to health inspections.

7. The system of claim 1 wherein the compliance reports are communicated to insurance companies.

8. The system of claim 1 wherein the system communicates with other databases.

9. The system of claim 8 wherein the user of the system is an individual and the system communicates with databases of regulatory agencies to determine whether the individual is properly licensed.

10. The method of claim 9 wherein if the individual is not properly licensed the system issues a notice of non-compliance.

11. A method of monitoring compliance with jurisdictional regulations comprising the steps of:
inspecting a location for compliance,
entered inspection compliance information using a client input device in communication with a server, the server comprising a database and a reporting program and the database comprising reporting data and location data;
executing on the server the reporting program; and
automatically communicating compliance reports to a jurisdictional authority in response to reporting data and location data in the database.

12. The method of claim 10 wherein the client device communicates with the server over a network.

13. The method of claim 10 further comprising the step of communicating compliance reports to management of the location.

14. The method of claim 10 further comprising the step of communicating compliance reports to at least one of an insurance company, an owner, an agent, a testing company, and an agency having jurisdiction over compliance.

15. The system of claim 10 wherein the step of entering data is performed by an individual and wherein method further comprises the step of the system communicating with databases of regulatory agencies to determine whether the individual is properly licensed.

16. The method of claim 15 wherein if the individual is not properly licensed the method includes the step of issuing a notice of non-compliance.

17. The method of claim 10 further comprising the step of determining the amount of time since the prior inspection.

18. The method of claim 17 further comprising the step of issuing a notice of non-compliance if the time since the prior inspection exceeds a specified amount.

19. A tangible memory device comprising a program for executing the method comprising:
entered inspection compliance information using a client input device in communication with a server, the server comprising a database and a reporting program and the database comprising reporting data and location data;
executing on the server the reporting program; and
automatically communicating compliance reports to a jurisdictional authority in response to reporting data and location data in the database.
